(19) United States
(12) Patent Application Publication
(10) Pub. No.: US 2018/0370015 A1
(43) Pub. Date: Dec. 27, 2018

(54) Battery-Powered Handheld Machine Tool

(71) Applicant: Hilti Aktiengesellschaft, Schaan (LI)

(72) Inventor: Konstantin BAXIVANELIS, Kaufering (DE)

(73) Assignee: Hilti Aktiengesellschaft, Schaan (LI)

(21) Appl. No.: 16/062,998

(22) PCT Filed: Dec. 13, 2016
(86) PCT No.: PCT/EP2016/080717

§ 371 Date: Jun. 15, 2018

(30) Foreign Application Priority Data
Dec. 17, 2015 (EP) 15200669.8

(51) Int. Cl. B25F 5/02; B23D 45/16; B23D 47/02; B27B 9/02; B27B 17/00; B23D 51/01

(52) U.S. Cl. CPC B25F 5/023; B23D 45/16; B23D 47/02; H01H 2009/065; B27B 17/0008; B23D 51/01; B27B 9/02

(57) ABSTRACT

A battery-powered handheld machine tool, particularly a circular saw, includes an electric motor for rotationally driving a tool that is arranged on the handheld machine tool, a front and a rear handle each in terms of an advancing direction of the handheld machine tool, and a receiving recess for receiving a replaceable battery. The rear handle is mounted such that it can pivot out laterally about a pivot axis so that when the rear handle is in a state of being pivoted out, the receiving recess is exposed for receiving or removing the replaceable battery, and so that when the rear handle is in a state of being pivoted in, the reception or removal of the replaceable battery into or out of the receiving recess is blocked.

### CROSS REFERENCE TO RELATED APPLICATIONS

This application claims the priority of International Application No. PCT/EP2016/080717, filed Dec. 13, 2016, and European Patent Document No. 15200669.8, filed Dec. 17, 2015, the disclosures of which are expressly incorporated by reference herein.

### BACKGROUND AND SUMMARY OF THE INVENTION

The present invention relates to a battery-powered handheld machine tool, particularly a handheld circular saw having an electric motor for rotationally driving a tool, particularly a saw blade, arranged on the handheld machine tool. The handheld machine tool has a front and rear handle, in each case relative to an advancing direction of the handheld machine tool. Furthermore, the handheld machine tool has a receiving recess for accommodating a replaceable battery. The replaceable battery is used to supply power to the electric motor.

Such handheld machine tools are basically known from prior art. Also known from prior art are handheld machine tools whose electric motor is designed to drive a tool, e.g., in the form of a saw blade, via a worm gear of the handheld machine tool. In such handheld machine tools, designed as handheld circular saws, that are known particularly from the US and typically referred to as “worm-drive saws” (WDS), the worm gear allows a right-angled arrangement of the motor axis (worm shaft) and the tool axis, i.e., saw blade axis (output axis for the saw blade). As a result, handheld circular saws designed as WDS have an elongated, less wide shape than the “side winders” (SW) preferred in Europe, in which the motor axis and saw blade axis are arranged coaxially, but at least parallel to each other.

The object of the present invention is to provide a handheld circular saw with improved handling.

The object is achieved in that the rear handle is mounted in a manner to be outwardly and laterally pivotable about a pivot axis in such a manner that when the rear handle is in a swiveled-out position, the receiving recess is opened to receive or remove the replaceable battery, and when the rear handle is in a swiveled-in position, receiving or removing the replaceable battery in or out of the receiving recess is blocked.

Advantageously, the battery-powered handheld machine tool according to the invention allows for a particularly easy insertion or removal of a replaceable battery. Already because of that, the handheld circular saw according to the invention has improved handling compared to battery-powered handheld machine tools, particularly handheld circular saws, known from prior art.

The invention also includes the knowledge that the elongated, less wide shape of the prior art handheld circular saws designed as WDS requires top-heavy ergonomics, which are preferred for so-called “drop cuts”, in other words, cuts in a vertical direction from top to bottom. In addition to the already mentioned advantageously simple battery replacement, the preferred ergonomics of a handheld circular saw designed as a WDS is at least favored in terms of design due to the fact that the receiving recess can be opened to receive the replacement battery by pivoting the rear handle.

Preferably, a length of the handheld machine tool along the advancing direction is at least twice as long as a width of the handheld machine tool transversely to the advancing direction. Within the scope of the present invention, the advancing direction refers to a thrust direction when working with the handheld machine tool as intended, i.e., in particular not a thrust direction possibly taken up temporarily to release a jammed tool, particularly a saw blade, out of a sawed piece.

In a particularly preferred design, the pivot axis is oriented in the advancing direction of the handheld circular saw. Preferably, the pivot axis has a pivot point, which lies above, preferably solely above, a base plane and/or lies below, preferably solely below, a parallel plane parallel to this base plane. The base plane may be spanned by a bottom side, contacting a work piece while in a working mode, of a base plate, in a zero-degree position and/or set to a maximal cutting depth, of a handheld machine tool. The base plate is in the zero-degree position when the bottom side, contacting a work piece while in a working mode, of the base plate is perpendicular to the planar saw blade.

The parallel plane parallel to the base plane preferably has a clearance to the base plane. In a preferred design, the rotation axis of the tool lies preferably in the parallel plane. In this preferred design, the pivot point is arranged preferably below the receiving recess and in a particularly preferred manner is designed in a stabilization rail of the handheld machine tool. In other words, in this preferred design, the rear handle is fastened “underneath” on the handheld circular saw.

It has proven to be advantageous if the pivot point preferably lies solely in a chamber side, facing the rear handle, of an axial plane, wherein the axial plane is spanned by the rotation axis and a radius of the tool. Preferably, the axial plane forms an angle of 90 degrees extending from a section, located in front of the rotation axis in the advancing direction, of a base plane and in the rotational direction of the tool.

In an also preferred manner, the center of gravity lies, preferably exclusively, in a chamber side, facing the front handle, of a clearance plane ABE. Preferably, the clearance plane is parallel to the axial plane and/or has a clearance to the axial plane, which is at least as large and/or no more than twice as large as a maximum possible tool diameter of a respective handheld machine tool.

The center of gravity can, preferably exclusively, lie in a chamber side, facing the front handle, of a handle plane. Preferably, the handle plane is spanned by the rotation axis and a radius of the tool, wherein the handle plane forms an angle of at least 20 degrees and preferably at least 30 degrees from a section, positioned behind the rotation axis in the advancing direction, of a base plane and in the opposite rotational direction of the tool. In this preferred design, the center of gravity is preferably arranged above the receiving recess and in an especially preferred manner designed in a mounting rail of the handheld machine tool. In other words, in this preferred design, the rear handle fastened at the “top” on the handheld machine tool.

It is explicitly pointed out here that the just specified position conditions of the pivot axis can apply singly as well as in combination. In this way, for example, the base plane, the axial plane, the clearance plane and the parallel plane enclose a spatial region in the form of a cuboid, in which the center of gravity is arranged or is to be arranged.

In a preferred design, the center of gravity lies in a stabilization rail of the handheld machine tool. Alternatively, the center of gravity can lie in a mounting rail of the handheld machine tool. The pivot axis can run through a cylinder pin, which is mounted in a pin receptacle.

It has proven to be advantageous when a pivot angle between a swiveled-in state and a swiveled-out state, limited by a pivot stop and a counter-stop, is greater than 30 degrees, preferably 90 degrees, and no more than 330 degrees.

Preferably, the handheld machine tool has a latch mechanism, which is designed to securely hold the rear handle in the swiveled-out state, preferably until the user overcomes a spring blocking force.

The spring blocking force may be designed for example by a pressure element having a ball and spring and at least one corresponding latch recess. Preferably, such a mechanism is designed near the pivot axis, which allows for a particularly compact structure. The latch mechanism can alternatively be designed by means of a magnetic pairing, preferably in the region of the pivot stop and/or the counter-stop. It is also possible to execute the latch mechanism by means of coil spring friction. Each one of these options is designed in such a manner that the rear handle is securely held in the swiveled-out state until a force applied by the user on the rear handle overcomes the spring blocking force of the latch mechanism.

In a particularly preferred design, the rear handle has a locking mechanism, which is designed to fix the rear handle in its swiveled-in state and/or if applicable to release it for a pivot motion. It has proven to be advantageous if, below the receiving recess, there is arranged a stabilization rail, which preferably protrudes opposite the advancing direction over the receiving recess, and to which the rear handle can be preferably fixed in its swiveled-in state.

A fixing of the rear handle in its swiveled-in state to the stabilization rail allows for high stability of the rear handle and thus an optimal force flow in the advancing direction of the handheld machine tool.

It has proven to be advantageous if the locking mechanism comprises a pin, which can engage for that purpose in a provided recess, which is preferably constructed on the stabilization rail or mounting rail. According to an alternative design form, the locking mechanism can also be designed by a hook with a corresponding eye. This is preferably when the rear handle is in a swiveled-in state. By means of such a locking mechanism, the rear handle is locked in such a manner that a particularly reliable operation of the handheld machine tool is achieved by preventing an undesired swiveling of the rear handle. The locking mechanism can be designed so that it locks automatically in a swiveled-in state. Alternatively, the locking mechanism can be designed to lock when the user actuates an operating element.

Preferably, safety of the handheld circular saw is increased by the fact that it has a safety switch, which is connected to the rear handle and is designed to interrupt power supplied to the electric motor in the unlocked state of the locking mechanism and/or when in a swiveled-out state. The safety switch can interrupt the main power supply of the handheld machine tool directly or send the status of the locking mechanism to an electronic system and prevent a startup of the handheld machine tool, particularly a saw, despite pressing on the on/off switch, by means of a logic controller provided in the electronic system. The safety switch can be designed in an electrical, magnetic and/or optical manner. Multiple possibilities for arranging the safety switch are conceivable. The safety switch can be part of the mechanical switching element, for example, or be connected to it mechanically. Alternatively or additionally, the safety switch can be arranged in the region of the pivot axis or the pivot point of the rear handle. Alternatively or additionally, it is conceivable to arrange the safety switch in a region of the rear handle, which, when in a swiveled-in state, is in contact with a replaceable battery held in the receiving recess. It was found to be advantageous to design the safety switch as part of the mechanical switching element.

In another preferred design, the receiving recess has a rail guide, by means of which the replaceable battery is pushed into the receiving recess and can be pulled out of it. Preferably the rail guide and/or the replaceable battery is designed in such a manner that pulling out the replaceable battery is only possible after actuating a release element. Preferably the release element is designed as a button and arranged on the replaceable battery.

It has also proven to be advantageous if a hand engagement surface of the rear handle, in relation to the advancing direction of the handheld machine tool, is accommodated behind the replaceable battery held in the receiving recess. In a particularly preferred design, the tool is arranged to the left or right, in relation to the advancing direction of the handheld machine tool, of the electric motor. The output shaft of the electric motor can run parallel to the rotation axis of the saw blade. The handheld circular saw is preferably at least twice as long as it is wide. Preferably the handheld circular saw is devoid of a worm gear. In this way, the battery-powered handheld machine tool, designed as a handheld circular saw, can for example achieve the ergonomics of a handheld machine tool provided as a WDS and designed in the form of a handheld circular saw.

Additional advantages emerge from the following drawing descriptions. The drawings depict various embodiments of the present invention. The drawings, the description and the claims contain numerous features in combination. A person skilled in the art will also consider the features individually for practical purposes and combine them into reasonable other combinations.

In the drawings, identical and similar components are labeled with identical reference signs.

### BRIEF DESCRIPTION OF THE DRAWINGS

FIG. 1 illustrates a first preferred embodiment of a battery-powered handheld machine tool according to the invention in the form of a handheld circular saw in a side view, wherein the rear handle is fastened below;

FIG. 2 is a rear view of the embodiment from FIG. 1, wherein the rear handle is in a swiveled-in state;

FIG. 3 is a rear view of the embodiment from FIG. 1, wherein the rear handle is in a swiveled-out state;

FIG. 4 is a perspective illustration of the view from FIG. 3, wherein the replaceable battery is outside the receiving recess;

FIG. 5 illustrates a second preferred embodiment of a battery-powered handheld machine tool according to the invention in the form of a handheld circular saw in a side view, wherein the rear handle is fastened at the top;

FIG. 6 is a rear view of the embodiment from FIG. 5, wherein the rear handle is in a swiveled-in state;

FIG. 7 is a rear view of the embodiment from FIG. 5, wherein the rear handle is in a swiveled-out state;

FIG. 8 is a perspective illustration of the view from FIG. 7, wherein the replaceable battery is outside the receiving recess; and

FIG. 9 is another perspective illustration of the view from FIG. 7.

### DETAILED DESCRIPTION OF THE DRAWINGS

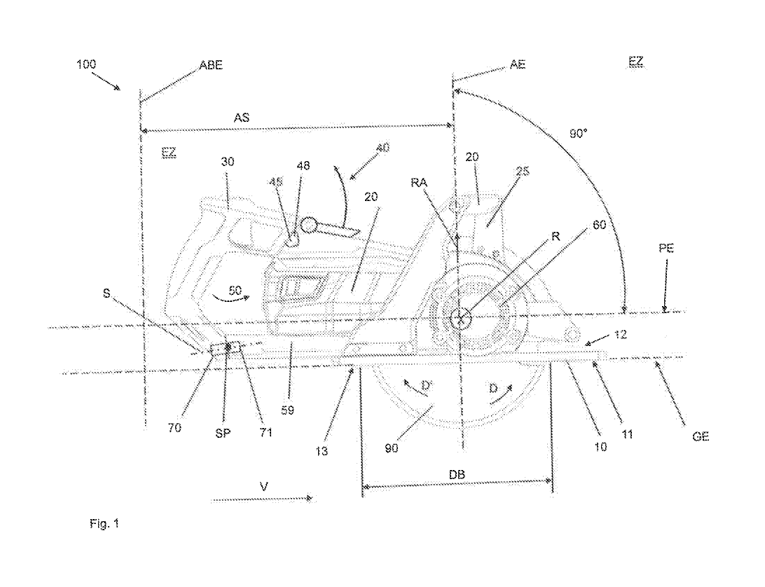

A preferred embodiment of a handheld machine tool 100 designed as a battery-powered handheld circular saw is depicted in FIG. 1. Battery-powered handheld circular saw 100 has an electric motor 60 for rotationally driving a tool 90 designed as a saw blade and arranged on handheld circular saw 100. Saw blade 90 is rotationally driven about a rotation axis R, which in this case points into the drawing plane. In the sawing mode as intended, saw blade 90 rotates in rotation direction D. In other words, saw blade 90 rotates in such a manner that handheld circular saw 100 in the sawing mode is pulled to a workpiece (not shown) to be sawed.

When normally operated as intended, handheld circular saw 100 is advanced in advancing direction V. The advancing direction is depicted in FIG. 1 with a horizontal arrow pointing to the right. Handheld circular saw 100 has a front handle 20 and a rear handle 30. In relation to advancing direction V of handheld circular saw 100, front handle 20 is arranged in front of rear handle 30.

In addition, handheld circular saw 100 has a receiving recess 50 for receiving a replaceable battery 200. In the embodiment shown in FIG. 1, replaceable battery 200 for operating electric motor 60 of handheld machine tool 100 designed as a handheld circular saw is completely accommodated in receiving recess 50.

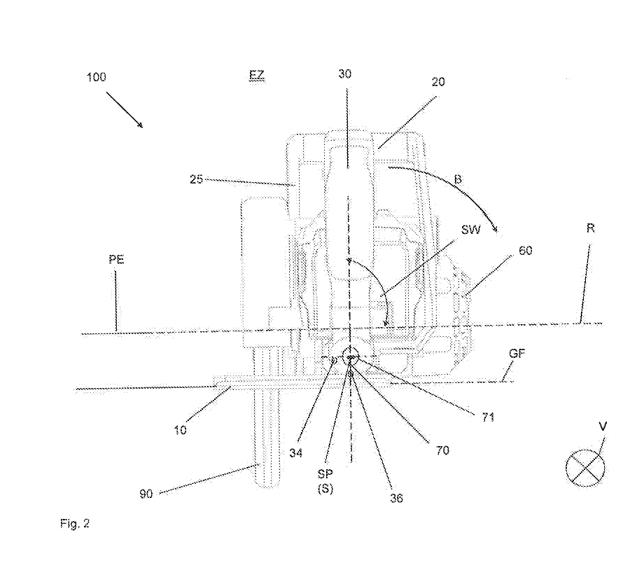

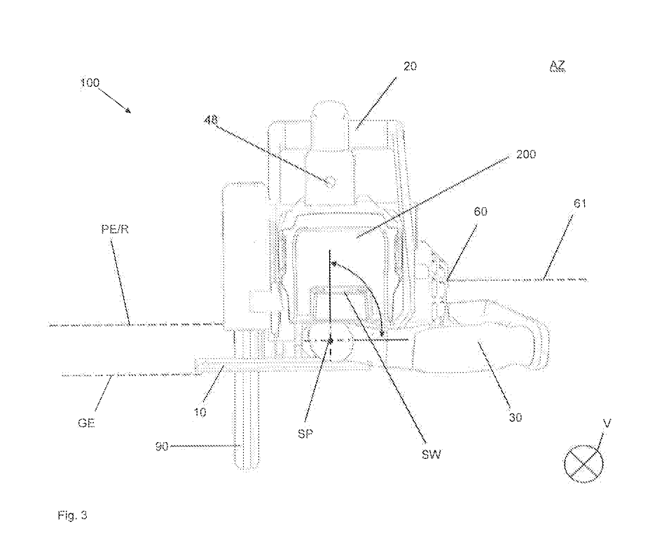

According to the invention, rear handle 30 is positioned in a pivotable manner about a pivot axis S. Rear handle 30 is pivotably positioned about pivot axis S in such a manner that when rear handle 30 is in a swiveled-out state (cf. FIG. 3), receiving recess 50 is open for receiving or removing replaceable battery 200. Furthermore, rear handle 30 is pivotably positioned about pivot axis S in such a manner that when rear handle 30 is in a swiveled-in state EZ (cf. FIGS. 1 and 2), receiving or removing replaceable battery 200 into or out of receiving recess 50 is blocked.

As one can see when looking at both FIGS. 2 and 3, rear handle 30 is positioned so as to be laterally pivotable in a downward direction, i.e., rear handle 30 pivots about an imaginary arc B (indicated in FIG. 2 by an arrow), whose inflection point lies on pivot axis S.

In a preferred embodiment of FIG. 1, pivot axis S is oriented in advancing direction V of handheld circular saw 100. Pivot axis S thereby does not necessarily lie parallel to advancing direction V, but can run slightly diagonal to advancing direction V—as one can see in FIG. 1—for example, with a maximum inclination angle of 20 degrees.

Pivot axis S runs exclusively above a base plane GE. Base plane GE can also be designed as a footplate plane. Base plane GE thereby corresponds to the footplate plane. Handheld machine tool 100 designed as a handheld circular saw has a base plate 10. The base plate can also be referred to as a footplate. This is particularly the case if the handheld machine tool contains a footplate. However, it is also possible that handheld machine tool 100 does not contain any base plate 10 or footplate. A base plane GE designed as a base plane is spanned by a bottom side 11, contacting a workpiece while in working mode, of a base plate 10, set to a zero-degree position and a maximum cutting depth, of handheld circular saw 100. Base plane GE spanned by bottom side 11 of base plate 10 is also illustrated in a perspective view of FIG. 2.

FIG. 1 depicts a parallel plane PE running parallel to base plane GE. The rotation axis R, pointing into the drawing plane, of tool 90 designed as a sawblade lies in this parallel plane PE. Pivot point SP lies exclusively below this parallel plane. In this way, rear handle 30 is fastened “below.”

FIG. 1 also depicts an axial plane AE, which is spanned by rotation axis R and a radius RA of saw blade 90. Axial plane AE forms an angle of exactly 90 degrees from a section 12, positioned in advancing direction V before rotation axis R, of base plate 10 and in rotation direction D of saw blade 90.

FIG. 1 also shows that pivot point SP lies exclusively in a chamber side, facing front handle 20, of a clearance plane ABE. Clearance plane ABE lies parallel to axial plane AE and has a clearance AS to this axial plane AE, the clearance AS being approximately twice as large, in the embodiment depicted here, as the maximum possible saw blade diameter DB of handheld circular saw 100.

Base plane GE, axial plane AE, clearance plane ABE and parallel plane PE form a spatial region in the form of a cuboid, in which pivot point SP is arranged. As one can also see in FIG. 1, pivot axis S runs through a stabilization rail 59 of handheld circular saw 100 and lies, relative to the vertical axis, below receiving recess 50. Base plate 10 is positioned on handle support 25, to which is also attached electric motor 60 and/or its housing. Pivot point SP lies at a distance from handle support 25 of front handle 20.

In reference to FIG. 2, the attachment of rear handle 30 to handheld machine tool 100 designed as a handheld circular saw is now to be explained in greater detail.

Rear handle 30 is pivotably mounted by means of a cylindrical pin 70, which runs coaxially to pivot axis S, in a pin receptacle 71 of a stabilization rail 59 of handheld circular saw 100. For this purpose, rear handle 30 has a non-depicted borehole through which cylinder pin 70 passes. FIG. 2 depicts rear handle 30 in a swiveled-in state EZ, so that the receiving or removing of replaceable battery 200 into or out of receiving recess 50 is blocked.

FIG. 2 now shows, in relation to advancing direction V, a rear view of handheld machine tool 100 designed as a handheld circular saw from FIG. 1. From the illustration of FIG. 2, one can see that saw blade 90 is arranged left of electric motor 60. Alternatively, saw blade 90 can also be arranged to the right of electric motor 60. Base plane (GE, which is spanned by bottom side 11 of base plate 10 and already explained in relation to FIG. 1, is also drawn in the illustration of FIG. 2 for the sake of clarity. As one can also see in FIG. 2, center of gravity SP lies between base plane GE and parallel plane PE. Rotation axis R in turn lies in parallel plane PE.

Now to be further described in relation to FIG. 2 is a pivot angle SW, which is defined between swiveled-in state EZ and swiveled-out state AZ of rear handle 30. FIG. 2 indicates a pivot stop 34 and a counter-stop 36 in the region of pin receptacle 71 (cf. FIG. 1), which limit pivot angle SW. For a pivot angle of 0 degrees, rear handle 30 is in a swiveled-in state EZ, which one can see for example in FIGS. 1 and 2.

In the embodiment of FIGS. 1 to 4, a pivot angle SW limited by pivot stop 34 and counter-stop 36 is exactly 90 degrees between swiveled-in state EZ and swiveled-out state AZ of rear handle 30. Pivot angle SW is in relation to rotation axis R in this case.

FIG. 3 depicts the embodiment of FIGS. 1 and 2, wherein in FIG. 3, rear handle 30 is shown in its swiveled-out state AZ. In swiveled-out state AZ, receiving recess 50 is open for receiving or removing replaceable battery 200. In FIG. 3, replaceable battery 200 is accommodated in the receiving recess. Based on swiveled-in state EZ of rear handle 30 in FIG. 2, FIG. 3 depicts the completely swiveled-out state AZ with a pivot angle SW of 90 degrees.

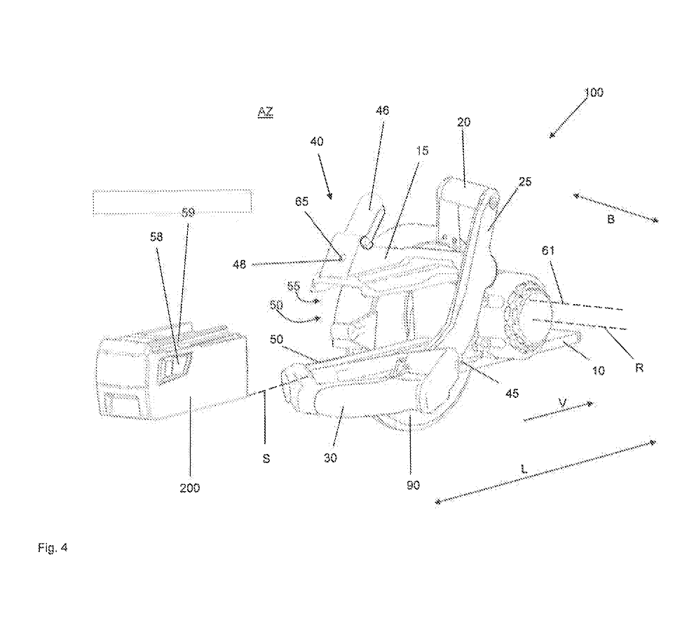

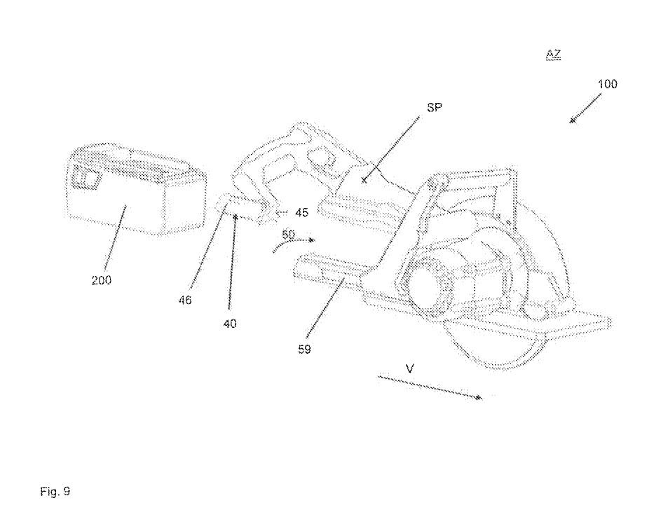

Special features of handheld machine tool 100 designed as a handheld circular saw are to be explained below with reference to FIG. 4. On a mounting rail 15 of handheld circular saw 100, there is arranged a locking mechanism 40, with which rear handle 30 can be secured in its swiveled-in state EZ and, if needed, can be opened for a pivot movement. Locking mechanism 40 has a mechanical switching element 46, by means of which a pin 45 (cf. FIG. 9), which is attached to the rear handle and which can engage in a corresponding recess 48, can be locked.

As one can see in FIG. 4, recess 48 is designed for mechanical switching element 45 on a mounting rail 15, and is arranged above receiving recess 50. In swiveled-in state EZ, switching element 45 is accommodated in recess 48, which is shown in FIG. 1.

FIG. 4 depicts a safety switch 65, which is arranged inside recess 48 in the embodiment shown in FIG. 4 and which can be actuated by pin 45. Safety switch 65 is designed to interrupt the power supply to electric motor 60 when locking mechanism 40 is in an unlocked state and when in a swiveled-out state AZ. If locking mechanism 40 is locked, or rear handle 30 is swiveled-in, as is the case in FIG. 1, then safety switch 65 signals that electric motor 60 can be actuated.

As one can also see in FIG. 4, handheld circular saw 100 has a mounting rail 15. This mounting rail 15 is designed to provide rear handle 30 a contact surface, in which recess 48 is designed. If rear handle 30 is in a swiveled-in state EZ (cf. FIG. 1), rear handle 30 is secured by pin 45 against an undesired turning transversely to pivot axis S.

Below mounting rail 15, there is designed a rail guide 55, by means of which replaceable battery 200 can be pushed into and pulled out of receiving recess 50. Rail guide 55 is designed in such a manner that pulling out replaceable battery 200 is first possible after actuating a release element 58 on replaceable battery 200. For that purpose and not depicted in FIG. 4, a lug 59 actuated by release element 58 protrudes into a corresponding recess (not shown) on the bottom side of mounting rail 15.

A motor shaft 61, shown in FIG. 4, of electric motor 60 runs parallel to rotation axis R of saw blade 60. Basically, motor shaft 61 and rotation axis 60 can run coaxially in all embodiments. A parallel offset variation of 61 and rotation axis 60 is (as shown) also conceivable, if for example a gear unit is provided between motor shaft 61 and saw blade 90.

A maximum length L, in relation to advancing direction V, of handheld machine tool 100 designed as a handheld circular saw is at least twice as long as a maximum width B, perpendicular to advancing direction V, of handheld machine tool 100 designed as a handheld circular saw.

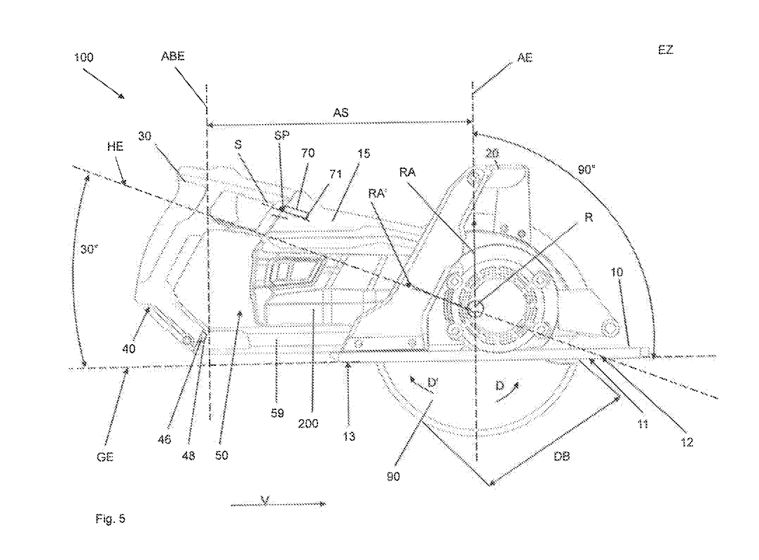

A second preferred embodiment of a battery-powered handheld circular saw 100 is shown in FIG. 5. Battery-powered handheld circular saw 100 has an electric motor 60 for rotationally driving a saw blade 90 arranged on handheld circular saw 100. Saw blade 90 is driven rotationally about a rotation axis R, which in this case points into the drawing plane. When used in sawing operations as intended, saw blade 90 rotates in rotation direction D. In other words, saw blade 90 rotates in such a manner that in a sawing operation, handheld circular saw 100 is pulled toward a workpiece (not shown) to be sawed.

When used as intended, handheld circular saw 100 is advanced in advancing direction V. The advancing direction is shown in FIG. 5 by means of a horizontal arrow pointing to the right. Handheld circular saw 100 has a front handle 20 and a rear handle 30. In relation to advancing direction V of handheld circular saw 100, front handle 20 is arranged in front of rear handle 30.

Furthermore, handheld circular saw 100 has a receiving recess 50 for accommodating a replaceable battery 200. In the embodiment shown in FIG. 1, replaceable battery 200 is fully accommodated in receiving recess 50 for operating electric motor 60 of handheld circular saw 100.

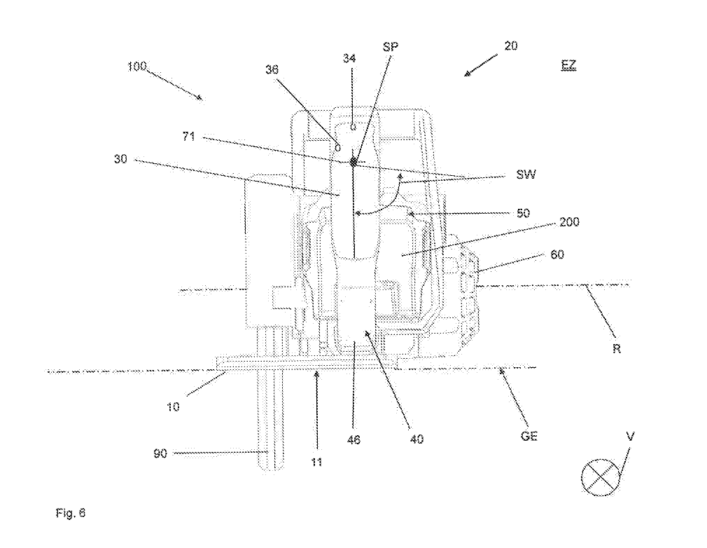

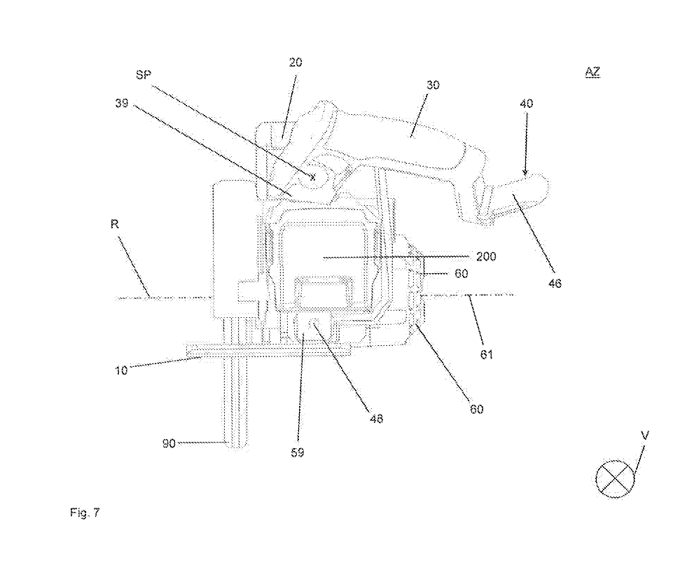

According to the invention, rear handle 30 is pivotably mounted about a pivot axis S. Rear handle 30 is pivotably mounted about pivot axis S in such a manner that when rear handle 30 is in a swiveled-out state (cf. FIG. 7), receiving recess 50 is open for receiving or removing replaceable battery 200. Furthermore, rear handle 30 is pivotably mounted about pivot axis S in such a manner that when rear handle 30 is in a swiveled-in state EZ (cf. FIGS. 5 and 6), receiving or removing replaceable battery 200 into or out of receiving recess 50 is blocked.

As one can see when viewing FIGS. 6 and 7 together, rear handle 30 is pivotably mounted in a laterally upward manner, i.e., rear handle 30 pivots about an imaginary arc (indicated in FIG. 2 by an arrow), whose inflection center point lies on pivot axis S.

In the embodiment of FIG. 5, pivot axis S is oriented in advancing direction V of handheld circular saw 100. Pivot axis S thereby does not necessarily lie parallel to advancing direction V, but can—as seen in FIG. 5—run slightly diagonal to advancing direction V, for example at a maximum inclination angle of 340 degrees (in the counterclockwise direction).

Pivot axis S has a center of gravity SP, which lies exclusively above a base plane GE. Base plane GE is spanned by a bottom side 11, contacting a workpiece when in operating mode, of a base plate 10, in a zero-degree setting and adjusted to the maximum cutting depth, of handheld circular saw 100. Base plane GE spanned by bottom side 11 of base plate 10 is also illustrated in the rear view of FIG. 6.

Also shown in FIG. 5 is an axial plane AE, which is spanned by rotation axis R and by a radius RA of saw blade 90. Axial plane AE forms an angle of exactly 90 degrees, extending from a section 12, located in front of rotation axis R in advancing direction V, of base plate 10 and in rotation direction D of saw blade 90.

Also shown in FIG. 5 is that center of gravity SP lies exclusively in a chamber side, facing front handle 20, of clearance plane ABE. Clearance plane ABE lies parallel to axial plane AE and has a clearance AS to this axial plane AE, the clearance AS being approximately twice as large, in the embodiment depicted here, as the maximum possible saw blade diameter DB of handheld circular saw 100.

Also shown in FIG. 5 is a handle plane HE, which is spanned by rotation axis R and a radius RA′ of saw blade 90. Handle plane HE forms, for example, an angle of 30 degrees, extending from a section 13, located behind rotation axis R in advancing direction V, of base plate 10 and in the opposite rotation direction D of saw blade 90. Center of gravity SP lies exclusively in a chamber side, facing front handle 20, of handle plane HE. In this way, rear handle 30 is fastened “at the top.” As one can also see in FIG. 5, pivot axis S runs through a mounting rail 15 of handheld circular saw 100. Pivot point 15 lies, in relation to the vertical axis, above receiving recess 50.

In the embodiment depicted here, handle plane HE, axial plane AE, clearance plane EBA and the base plane define a blunt wedge-shaped chamber region, which is devoid of center of gravity 15.

FIG. 6 now shows, in relation to advancing direction V, a rear view of handheld circular saw 100 from FIG. 5. From the illustration of FIG. 6, one can see that saw blade 90 is arranged to the left of electric motor 60. Alternatively, tool 90 designed as a saw blade can also be arranged to the right of electric motor 60, in relation to advancing direction V of handheld machine tool 100. Base plane GE, already explained in relation to FIG. 5 and which is spanned by bottom side 11 of base plate 10, is also drawn in the illustration of FIG. 6 for the sake of clarity. As one can also readily see in FIG. 2, center of gravity SP lies above base plane GE and above replaceable battery 200 accommodated in receiving recess 50.

In relation to FIG. 6, a pivot angle SW, which is defined between a swiveled-in state EZ and swiveled-out state AZ of rear handle 30, is to be described in greater detail. Indicated in FIG. 6 is a pivot stop 34 and a counter-stop 36 in the region of pin receptacle 71 (cf. FIG. 1), which limit pivot angle SW. Pivot stop 34 and counter-stop 36 are to be understood as being illustrative and may be executed by corresponding recesses or protrusions in the housing of handheld circular saw 100. Given a pivot angle of 0 degrees, rear handle 30 is in a swiveled-in state EZ, which can also be seen for example in FIG. 5.

FIG. 7 depicts the embodiment of FIGS. 5 and 6, wherein FIG. 7 shows rear handle 30 in its swiveled-out state AZ. In swiveled-out state AZ, receiving recess 50 is open for receiving or removing replaceable battery 200. In FIG. 7, replaceable battery 200 is removed from the receiving recess. Based on a swiveled-in state EZ of rear handle 30 in FIG. 6, FIG. 7 depicts the fully swiveled-out state AZ with a pivot angle of approx. 80 degrees (cf. FIG. 7, defined in the counterclockwise direction).

Special safety features of handheld circular saw 100 will be explained below in reference to FIGS. 6 to 9. These essentially correspond to the safety features described in relation to the first embodiment, wherein only their arrangement on handheld circular saw 100 is different.

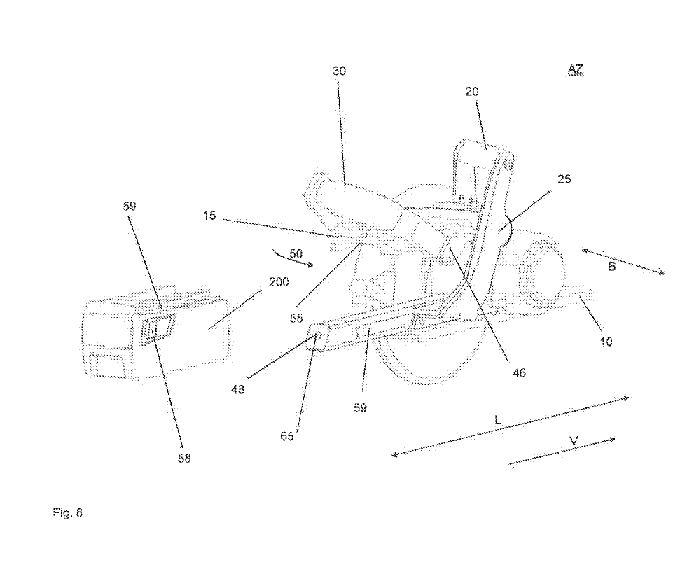

On rear handle 30 of handheld circular saw 100, there is designed a locking mechanism 40, with which rear handle 30 can be secured in its swiveled-in state EZ (cf. FIG. 6) and can be opened if applicable for a pivot motion. Locking mechanism 40 has a mechanical switching element 46, by means of which a pin (cf. FIG. 9), which is affixed to rear handle 30 and which can engage in a corresponding recess 48 (cf. FIGS. 7 and 8), can be locked.

As can be seen in FIGS. 7 and 8, recess 48 for pin 45 is designed at a stabilization rail 59, which is arranged below receiving recess 50. In swiveled-in state EZ, switching element 45 is accommodated in recess 48, which is shown in FIG. 5.

FIG. 8 in turn depicts a safety switch 65, which is arranged inside recess 48 in the embodiment depicted in FIG. 8 and can be actuated by pin 45 (cf. FIG. 9). In the unlocked state of locking mechanism 40 and when in a swiveled-out state AZ, safety switch 65 is designed to interrupt the power supplied to electric motor 60. If locking mechanism 40 is locked or rear handle 30 is swiveled in, as is the case in FIG. 5, then safety switch 65 signals that electric motor 60 may be actuated.

As can also be seen in FIG. 8, handheld circular saw 100 has a stabilization rail 59. This stabilization rail 59 is designed to provide rear handle 30 with a contact surface, into which recess 48 is constructed. When rear handle 30 is in a swiveled-in state EZ (cf. FIG. 5), then rear handle 30 is secured by pin 45 against undesired turning transversely to pivot axis S.

Below a mounting rail 15 encompassed by the handheld circular saw, there is designed a rail guide 55, by means of which replaceable battery 200 can be pushed into and pulled out of receiving recess 50. Rail guide 55 is designed in such a manner that pulling out replaceable battery 200 can first occur after actuating a release element 58 on replaceable battery 200. To this end, a lug 59 also visible in FIG. 8 and actuated by release element 58 protrudes into a corresponding recess (not shown) on the bottom side of mounting rail 15.

A motor shaft 61, indicated in FIG. 7, of electric motor 60 runs parallel to rotation axis R of tool 90 designed as a saw blade. Basically, motor shaft 61 and rotation axis 60 can run coaxially in all embodiments. Even a parallel offset course of motor shaft 61 and rotation axis 60 (as shown) is conceivable, when for example a gear unit is provided between motor shaft 61 and saw blade 90. Handheld machine tool 100 designed as a handheld circular saw also has a latch mechanism 39, not shown in greater detail here, which is designed to secure rear handle 30 in depicted swiveled-out state AZ until the user overcomes a spring blocking force.

In relation to advancing direction V, maximum length L of handheld machine tool 100 designed as a handheld circular saw is at least twice as long as a maximum width B, perpendicular to advancing direction V, of handheld machine tool 100 designed as a handheld circular saw (cf. FIG. 8).

### LIST OF REFERENCE SIGNS

10 Base plate
11 Bottom side of base plate
12 Lead section
13 Trailing section
15 Rail guide
20 Front handle
25 Handle carrier of front handle
30 Rear handle
31 hand engagement surface
32 Pivot section
34 Pivot stop
36 Counter-stop
38 Profile of pivot arm
39 Latch mechanism
40 Locking mechanism
45 Pin
46 Mechanical switching element
48 Recess
50 Receiving recess
55 Rail guide
58 Release element
59 Stabilization rail
60 Electric motor
61 Motor shaft
65 Safety switch
70 Cylindrical pin
71 Pin receptacle
90 Tool
100 Handheld machine tool
200 Replaceable battery
AE Axial plane
ABE Clearance plane
GE Base plane
PE Parallel plane
D Turning axis
R Rotation axis
RA, RA′ Radius
S Pivot axis
SW Pivot angle
V Advancing direction

1.-16. (canceled)

17. A battery-powered handheld machine tool, comprising:
an electric motor for rotationally driving a tool disposed on the handheld machine tool;
a front handle and a rear handle with respect to an advancing direction of the handheld machine tool; and
a receiving recess for accommodating a replaceable battery;
wherein the rear handle is pivotably mounted about a pivot axis such that the rear handle is pivotable out laterally, wherein when the rear handle is in a swiveled-out state the receiving recess is open for receiving or removing the replaceable battery and wherein when the rear handle is in a swiveled-in state the receiving or the removing of the replaceable battery into or out of the receiving recess is blocked.

18. The handheld machine tool according to claim 17, wherein the pivot axis is oriented in the advancing direction of the handheld machine tool and the pivot axis has a center of gravity which lies above a base plane and/or below a parallel plane parallel to the base plane, wherein the base plane is spanned by a bottom side, which contacts a workpiece when in an operating mode, of a base plate in a zero-degree position and set to a maximum cutting depth of the handheld machine tool.

19. The handheld machine tool according to claim 18, wherein the center of gravity lies exclusively in a chamber side, facing the rear handle, of an axial plane, wherein the axial plane is spanned by a rotation axis and a radius of the tool, wherein the axial plane, extending from a section, positioned in front of the rotation axis in the advancing direction, of the base plane and in a rotation direction of the tool, forms an angle of 90 degrees.

20. The handheld machine tool according to claim 18, wherein the center of gravity lies exclusively in a chamber side, facing the front handle, of a clearance plane, wherein the clearance plane is parallel to an axial plane and has a clearance to the axial plane, wherein the clearance exactly as large and/or no more than twice as large as a maximum possible tool diameter of the handheld machine tool.

21. The handheld machine tool according to claim 18, wherein the center of gravity lies exclusively in a chamber side, facing the front handle, of a handle plane, wherein the handle plane is spanned by a rotation axis and a radius of the tool, wherein the handle plane, extending from a section, located behind the rotation axis in the advancing direction, of the base plane and in an opposite rotation direction of the tool, forms an angle of at least 20 degrees.

22. The handheld machine tool according to claim 17, wherein the pivot axis runs through a cylindrical pin which is mounted in a pin receptacle.

23. The handheld machine tool according to claim 17, wherein a pivot angle, limited by a pivot stop and a counter-stop, between the swiveled-in state and the swiveled-out state of the rear handle is greater than 30.

24. The handheld machine tool according to claim 17 further comprising a latch mechanism, wherein the latch mechanism secures the rear handle in the swiveled-out state until a user overcomes a spring blocking force.

25. The handheld machine tool according to claim 17, wherein the rear handle has a locking mechanism, wherein the locking mechanism secures the rear handle in the swiveled-in state.

26. The handheld machine tool according to claim 25, wherein a stabilization rail is disposed below the receiving recess which protrudes, opposite to the advancing direction, beyond the receiving recess and wherein the rear handle is securable to the stabilization rail in the swiveled-in state.

27. The handheld machine tool according to claim 26, wherein the locking mechanism comprises a pin which is engageable in a recess on the stabilization rail when the rear handle is in the swiveled-in state.

28. The handheld machine tool according to claim 27, wherein a safety switch is connected to the rear handle and interrupts a power supplied to the electric motor in an unlocked state of the locking mechanism and/or when the rear handle is in the swiveled-out state.

29. The handheld machine tool according to claim 17, wherein the receiving recess has a rail guide via which the replaceable battery is pushable into and pullable out of the receiving recess, wherein the rail guide and/or the replaceable battery is configured such that pulling out the replaceable battery is first possible after actuating a release element.

30. The handheld machine tool according to claim 17, wherein a hand engagement surface of the rear handle, in relation to the advancing direction of the handheld machine tool, is accommodated behind the replaceable battery accommodated in the receiving recess.

31. The handheld machine tool according to claim 17, wherein the tool is arranged to a left of the electric motor in relation to the advancing direction of the handheld machine tool, wherein an output shaft of the electric motor runs parallel to a rotation axis of the tool, and wherein the handheld machine tool is at least twice as long as it is wide.

32. The handheld machine tool according to claim 17, wherein the tool is arranged to a right of the electric motor in relation to the advancing direction of the handheld machine tool, wherein an output shaft of the electric motor runs parallel to a rotation axis of the tool, and wherein the handheld machine tool is at least twice as long as it is wide.
